(19) United States
(12) Patent Application Publication
(10) Pub. No.: US 2006/0103594 A1
(43) Pub. Date: May 18, 2006

(54) Plasma display apparatus and method of driving the same

(76) Inventors: Jin Young Kim, Dalseo-gu (KR); Hee Chan Yang, Suyeong-gu (KR); Yun Kwon Jung, Gumi-si (KR)

Correspondence Address: MCKENNA LONG & ALDRIDGE LLP, 1900 K STREET, NW, WASHINGTON, DC, 20006, US

(21) Appl. No.: 11/166,127

(22) Filed: Jun. 27, 2005

(30) Foreign Application Priority Data
Nov. 16, 2004 (KR) 10-2004-0093723

(51) Int. Cl. G09G 3/28

(52) U.S. Cl. 345/60

(57) ABSTRACT

The present invention relates to a plasma display panel that includes a scan electrode, a sustain electrode, and a plurality of address electrodes crossing the scan electrode and the sustain electrode. An electrode driver is provided for driving the scan electrode, the sustain electrode, and the address electrode. A controller is provided for controlling the electrode driver, such that, in at least one sub-field of a frame, the application time of a data pulse applied to at least one of a plurality of address electrode groups during the address period is different from that of a scan pulse applied to the scan electrode, and the width of a first sustain pulse applied during the sustain period is greater than that of another sustain pulse applied during the sustain period.

This application claims the benefit of Korean Patent Application No. 10-2004-0093723, filed on Jun. 11, 2004, which is hereby incorporated by reference for all purposes as if fully set forth herein.

### BACKGROUND OF THE INVENTION

1. Field of the Invention

The present invention relates to a plasma display panel, and more particularly, a plasma display apparatus and method of driving same, wherein noise occurring in waveforms applied to scan and sustain electrodes is alleviated to stabilize the address discharge and generate an adequate sustain discharge, thereby increasing the driving efficiency of the plasma display apparatus.

2. Background of the Related Art

Generally, in a plasma display panel, barrier ribs formed between a front substrate and a rear substrate form unit or discharge cells. Each of the cells is filled with a main discharge gas, such as neon (Ne), helium (He), or a mixture of Ne and He, and an inert gas containing a small amount of xenon. When it is discharged by a high frequency voltage, the inert gas generates vacuum ultraviolet rays, which thereby cause phosphors formed between the barrier ribs to emit light, thus displaying an image. Because the plasma display panel can be made with a thin and/or slim form, it has attracted attention as a next-generation display device.

FIG. 1 is a perspective view illustrating the configuration of a conventional plasma display panel. As shown in FIG. 1, the plasma display panel includes a front substrate 100 and a rear substrate 110 disposed parallel to each other with a gap in-between. The front substrate 100 has a plurality of electrode pairs arranged on a front glass 101, which serves as the display surface. Each electrode pair is formed of a scan electrode 102 and a sustain electrode 103. The rear substrate 110 is provided with a plurality of address electrodes 113 arranged on a rear glass 111, which constitutes a rear surface. The address electrode 113 is formed so as to cross the electrode pairs 102 and 103.

Both the scan electrode 102 and the sustain electrode 103 are formed of a transparent electrode “a” made of a transparent ITO material and a bus electrode “b” made of a metallic material. The scan electrode 102 and the sustain electrode 103 are covered with one or more upper dielectric layers 104 to limit discharge current and provide insulation among the electrode pairs. A protection layer 105 having magnesium oxide (MgO) deposited thereon in order to facilitate a discharge condition is formed on top of the upper dielectric layer 104.

In the rear substrate 110, barrier ribs 112 are arranged in the form of a stripe pattern (or a well type) such that a plurality of discharge spaces or discharge cells are formed in parallel. Furthermore, a plurality of address electrodes 113 for performing an address discharge to generate vacuum ultraviolet rays are disposed parallel to the barrier ribs 112. The top surface of the rear substrate 110 is coated with R, G, and B phosphors 114 for emitting visible rays for an image display when an address discharge is carried out. A lower dielectric layer 115 is formed between the address electrodes 113 and the phosphors 114 for protecting the address electrodes 113.

The plasma display panel includes a plurality of discharge cells in a matrix formation, and is provided with a driving module (not shown) having a driving circuit for supplying a predetermined pulse to the discharge cells. The interconnection between the plasma display panel and the driving module is illustrated in FIG. 2.

As illustrated in FIG. 2, the driving module includes, for example, a data driver integrated circuit (IC) 20, a scan driver IC 21, and a sustain board 23. The data driver IC 20 supplies a data pulse to the plasma display panel 22 after an image signal is processed. Also, the plasma display panel receives a scan pulse and a sustain pulse output from the scan driver IC 21 and a sustain signal output from the sustain board 23. A discharge is generated in a cell selected by the scan pulse among the plurality of the cells included in the plasma display panel 22, which has received the data pulse, the scan pulse, the sustain pulse, and the like. The cell where discharge has occurred emits light with a predetermined brightness. Tthe data driver IC 20 outputs a predetermined data pulse to each of the address electrodes X₁ to Xₙ through a connector such as a FPC (Flexible Printed Circuit) (not shown). In this case, the X electrodes refer to the data electrodes.

FIG. 3 illustrates a method for implementing image gradation or gray scale in a conventional plasma display panel. As illustrated in FIG. 3, a frame is divided into a plurality of sub-fields having a different number of emission times. Each sub-field is subdivided into a reset period (RPD) for initializing all the cells, an address period (APD) for selecting the cell(s) to be discharged, and a sustain period (SPD) for implementing the gray scale according to the number of discharges. For example, if an image with 256 gradation levels is to be dipslayed, the frame period (for example, 16.67 ms) corresponding to 1/60 second is divided into eight sub-fields SF1 to SF8, and each of the eight sub-fields SF1 to SF8 are subdivided into a reset period, an address period and a sustain period, as illustrated in FIG. 3.

The reset and address period is the same for every sub-field. However, the sustain period increases by a ratio of 2ⁿ (where, n=0, 1, 2, 3, 4, 5, 6, 7) for each sub-field SF1 to SF8, as shown in FIG. 3. Since the sustain period varies from one sub-field to the next, a specific grey level is achieved by controlling which sustain periods are to be used for discharging each of the selected cells, i.e., the number of the sustain discharges that are realized in each of the discharge cells.

FIG. 4 illustrates a driving waveform according to a conventional method for driving a plasma display panel. As shown, during a given sub-field, the waveforms associated with the X, Y, and Z electrodes are divided into a reset period for initializing all the cells, an address period for selecting the cells to be discharged, a sustain period for maintaining discharging of the selected cells, and an erase period for eliminating wall charges within each of the discharge cells.

The reset period is further divided into a set-up and set-down period. During the set-up period, a ramp-up waveform (Ramp-up) is applied to all the scan electrodes at the same time. This results in wall charges of a positive polarity being built up on the address electrodes and the sustain electrodes, and wall charges of a negative polarity being built up on the scan electrodes.

During the set-down period, a ramp-down waveform (Ramp-down), which falls from a positive polarity voltage lower than the peak voltage of the ramp-up waveform to a given voltage lower than a ground level voltage is applied to all the scan electrode at the same time, causing a weak erase discharge within the cells. Furthermore, the remaining wall charges are uniform inside the cells to the extent that the address charge can be stably performed.

During the address period, a scan pulse with a negative polarity is applied sequentially to the scan electrodes, and a data pulse with a positive polarity is selectively applied to specific address electrodes in synchronization with the scan pulse. As the voltage difference between the scan pulse and the data pulse is added to the wall voltage generated during the reset period, an address discharge is generated in the cells to which the data pulse is applied. A wall charge is formed inside the selected cells such that when a sustain voltage Vs is applied a discharge occurs. A positive polarity voltage Vz is applied to the sustain electrodes so that erroneous discharge does not occur with the scan electrode by reducing the voltage difference between the sustain electrodes and the scan electrodes during the set-down period and the address period.

During the sustain period, a sustain pulse is alternately applied to the scan electrodes and the sustain electrodes. Every time a sustain pulse is applied, a sustain discharge or display discharge is generated in the cells selected during the address period.

Finally, during the erase period, (i.e., after the sustain discharge is completed) an erase ramp waveform (Ramp-ers) having a small pulse width and a low voltage level, is applied to the sustain electrodes to erase the remaining wall charges within all the cells.

As discussed above, during the address period the scan pulses and data pulses have the same application time point (i.e., the pulses are applied to the respective electrodes at the same point in time). As illustrated in FIG. 5, according to the conventional driving method, a data pulse is applied to the address electrodes X₁ to Xₙ, at the same time ts that a scan pulse is applied to the scan electrodes. However, when the data pulse and the scan pulse are applied at the same time, noise occurs in the waveforms applied to the scan and sustain electrodes, as illustrated in FIG. 6.

This noise is generated due to coupling through the capacitance of the panel. As illustrated in FIG. 6, noise is generated in the waveforms applied to the scan electrodes and the sustain electrodes at the leading and trailing edges of the data pulse, i.e., when the data pulse abruptly rises and falls. This noise causes the address discharge to become unstable, thereby degrading the driving efficiency of a plasma display panel.

### SUMMARY OF THE INVENTION

Accordingly, the present invention is directed to a plasma display apparatus and method of driving same that substantially obviates one or more of the problems due to limitations and disadvantages of the related art.

An advantage of the present invention is that it provides a plasma display apparatus and method of driving the same, in which an application time point of a data pulse applied to an address electrode in an address period is different from that of a scan pulse applied to a scan electrode, and the width of a sustain pulse applied during a sustain period is controlled.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described a method for driving a plasma display panel, the plasma display panel comprising a scan electrode, a plurality of address electrodes crossing the scan electrode, and a controller for driver the panel, is provided that includes dividing the plurality of address electrodes into a plurality of address electrode groups; applying a data pulse to each of the plurality of address electrode groups in association with a scan pulse, wherein an application time point for at least one of the plurality of address electrode groups is different from that of the other data electrode groups during an address period of at least one sub-field, and wherein the width of a least one sustain pulse applied to the scan electrode during a sustain period of the at least one sub-field is greater than that of another sustain pulse applied to the scan electrode during the at least one sub-field.

In another aspect of the present invention, a plasma display apparatus is provided that includes a scan electrode; a plurality of address electrodes, the plurality of address electrodes crossing the scan electrode; a scan driver for driving the scan electrode; a data driver for driving the plurality of address electrodes; and a controller for applying a data pulse to each of a plurality of data electrode groups in association with a scan pulse, wherein an application time point for at least one of the plurality of data electrode groups is different from that of the other data electrode groups during an address period of at least one subfield, where each of the plurality of data electrode groups includes one or more data electrodes; and wherein the width of a first sustain pulse applied to the scan electrode after the address period of the at least one subfield is wider than that of another sustain pulse applied to the scan electrode during the at least one subfield.

It is to be understood that both the foregoing general description and the following detailed description are exemplary and explanatory and are intended to provide further explanation of the invention as claimed.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention.

In the drawings:

FIG. 1 is a perspective view illustrating the configuration of a conventional plasma display panel;

FIG. 2 is a perspective view illustrating an interconnection between the plasma display panel and the driving module;

FIG. 3 illustrates a method of implementing grey scale in a conventional plasma display panel;

FIG. 4 illustrates a driving waveform according to a conventional method of driving a plasma display panel;

FIG. 5 illustrates application time points of pulses being applied during an address period in a conventional method of driving a plasma display panel;

FIG. 6 is a diagram illustrating the noise generated in a conventional method of driving a plasma display panel;

FIG. 7 illustrates a plasma display apparatus according to an embodiment of the invention;

FIGS. 8a to 8c illustrate a driving waveform according to a method of driving the plasma display panel of the invention;

FIGS. 9a to 9e illustrate exemplary application time points according to the invention;

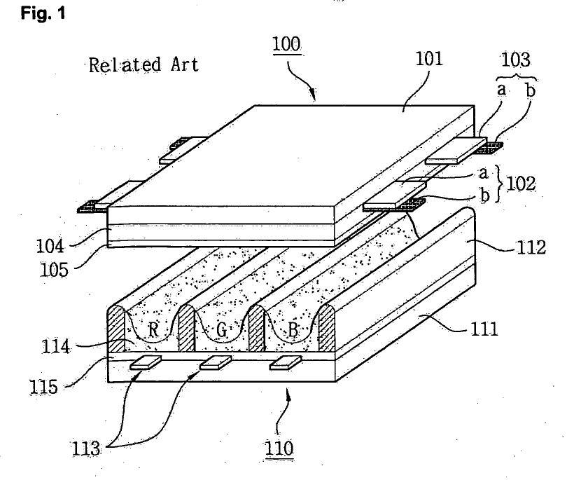

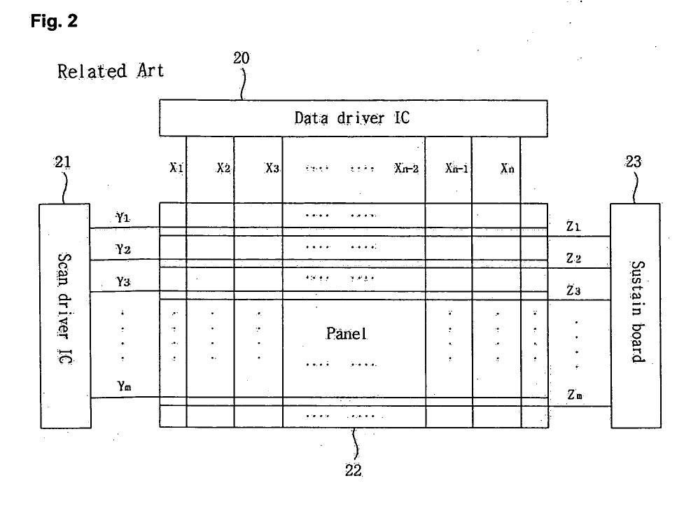

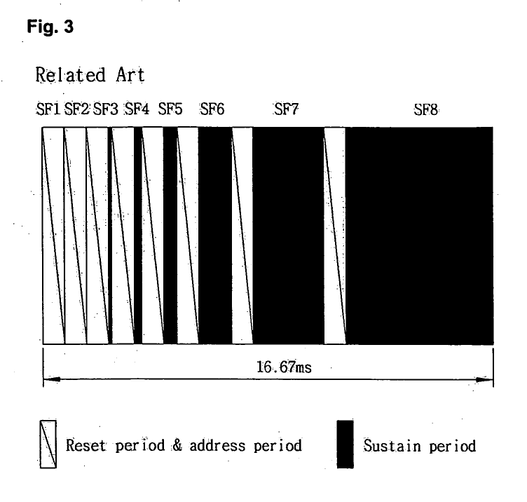

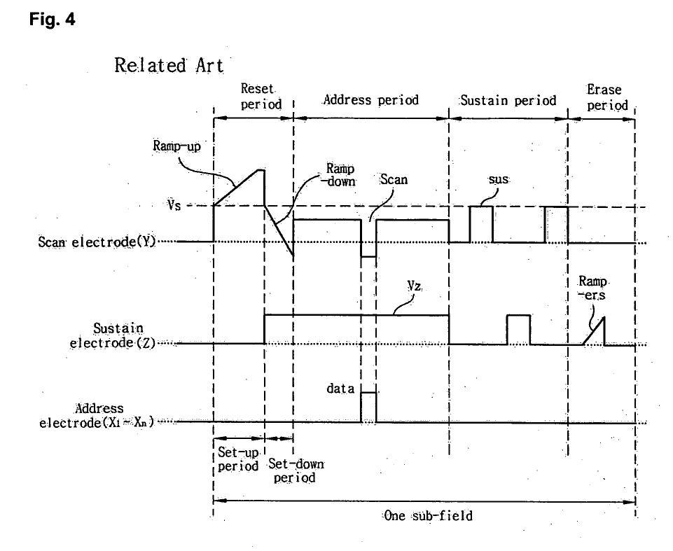

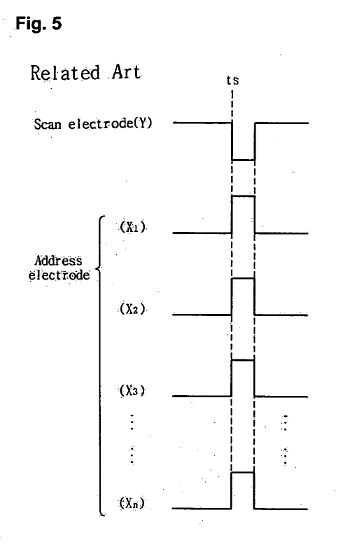

FIGS. 1Oa and 1Ob illustrate reduced in noise in a driving waveform according to the invention;

FIG. 11 illustrates a plasma display apparatus according to an embodiment of the invention;

FIGS. 12a to 12c illustrate exemplary application time points according to another embodiment of the invention;

FIG. 13 illustrates a driving waveform according to a method of driving the plasma display panel of the invention, where the application time points of a scan pulse and a data pulse are different from each other within each sub-field of a frame; and

FIGS. 14a to 14c are an enlarged views respectively of the areas D, E, and F in FIG. 13.

### DETAILED DESCRIPTION OF THE PREFERRED EMBODIMENT

Reference will now be made in detail to embodiments of the present invention, examples of which are illustrated in the accompanying drawings.

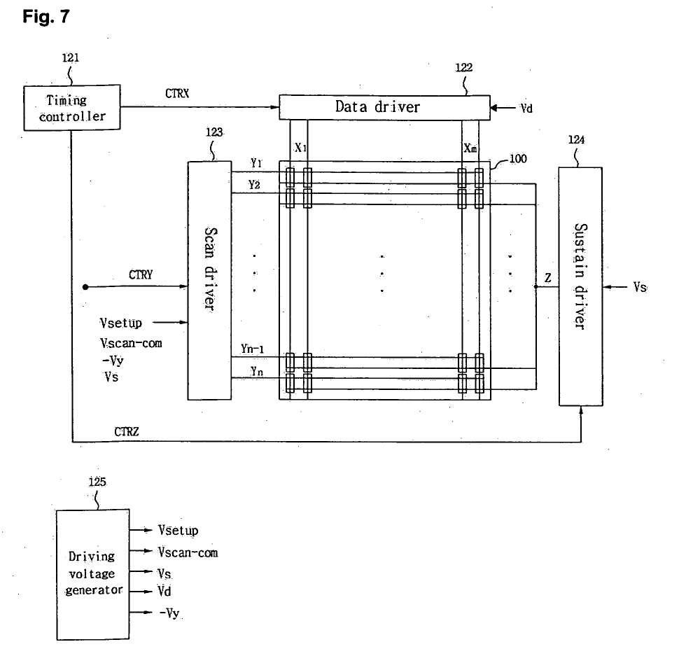

FIG. 7 illustrates a plasma display apparatus according to embodiments of the invention. The plasma display apparatus includes a plasma display panel 100, a data driver 122 for supplying data to address electrodes X₁ to Xₘ, a scan driver 123 for driving scan electrodes Y₁ to Yₙ, a sustain driver 124 for driving sustain electrodes Z which are common electrodes, a timing controller 121 for controlling the data driver 122, the scan driver 123, the sustain driver 124, and a driving voltage generator 125 for supplying the driving voltage required for each driver 122, 123, 124.

The plasma display panel 100 is formed of an upper substrate (not shown) and a lower substrate (not shown), which are combined with a predetermined gap in between. A plurality of electrodes, for example, scan electrodes Y₁ to Yₙ and sustain electrodes Z are formed in pairs in the upper substrate. Address electrodes X₁ to Xₘ, which cross the scan electrodes Y₁ to Yₙ and the sustain electrodes Z are formed in the lower substrate.

The data driver 122 receives data mapped for each sub-field by a sub-field mapping circuit after being inverse-gamma corrected and error-diffused through an inverse gamma correction circuit, an error diffusion circuit, or the like. The data driver 122 samples and latches the mapped data in response to a timing control signal CTRX from the timing controller 121, and then supplies the data to address electrodes X₁ to Xₘ.

The scan driver 123, under the control of the timing controller 121, supplies a ramp-up waveform and a ramp-down waveform to the scan electrodes Y₁ to Yₙ, during a reset period. In addition, the scan driver 123, sequentially supplies a scan pulse of scan voltage (−Vy) to the scan electrodes Y1 to Yn during the address period, and supplies a sustain pulse (sus) to the scan electrodes Y₁ to Yₙ during the sustain period. Accordingly, the timing controller controls the application time points of the data pulses applied to address electrodes X₁ to Xₘ and the scan pulses applied to the scan electrodes Y₁ to Yₙ.

The sustain driver 124, under the control of the timing controller 121, supplies a bias voltage (Vs) to the sustain electrodes Z during the set-down period and the address period. During the sustain period, the sustain driver 124 operates alternately with the scan driver 123 to supply a sustain pulse to the sustain electrodes Z. Furthermore, width of the sustain pulse supplied by the sustain driver 124 is controlled such that the width of the sustain pulse applied first during the sustain period is larger than that of other sustain pulse. In other words, the first sustain pulse supplied after the address period has a width greater than the width of another sustain pulse applied during the sustain period.

The timing controller 121 receives a vertical/horizontal synchronizing signal and a clock signal (not shown) and generates control signals CTRX, CTRY, and CTRZ for controlling the operation timing and synchronization of each driver 122, 123, 124. In particular, the data driver 122 and the scan driver 123 are controlled such that the address electrodes during at least one sub-filed of a frame are divided into a plurality of address electrode groups, and the application time point of the data pulses applied to at least one of the address electrode groups during the address period is different from that of a scan pulse applied to the scan electrode. The sustain driver 124 is controlled such that the width of a first sustain pulse applied during a sustain period is wider than that of another sustain pulse.

The data control signal CTRX includes a sampling clock for sampling data, a latch control signal, and a switch control signal for controlling the on/off time of an energy recovery circuit and a driving switch element. The scan control signal CTRY includes a switch control signal for controlling the on/off time of the energy recovery circuit and the driving switch element within the scan driver 123. The sustain control signal CTRZ includes a switch control signal for controlling on/off time of the energy recovery circuit and the driving switch element inside the sustain driver 124.

The driving voltage generator 125 generates the voltages necessary to driver the display panel, for example, a set-up voltage Vsetup, a scan common voltage Vscan-com, a scan voltage −Vy, a sustain voltage Vs, a data voltage Vd, and the like. These driving voltages may vary with the composition of the discharge gas or the structure of the discharge cells.

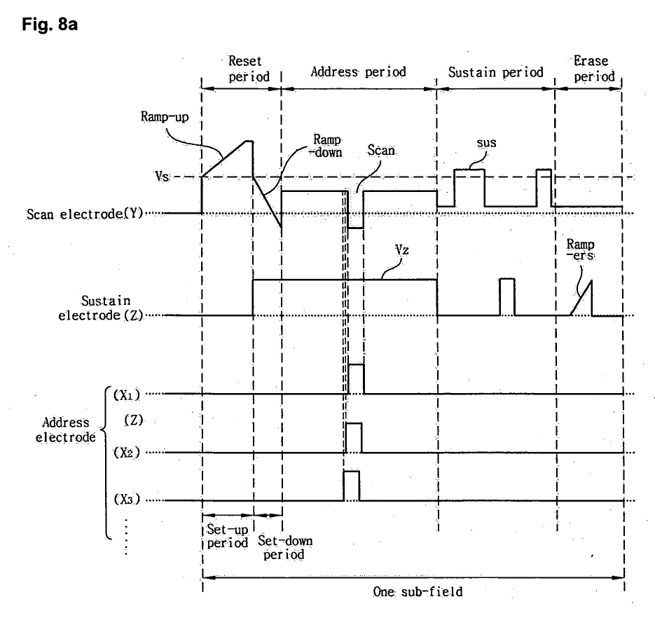

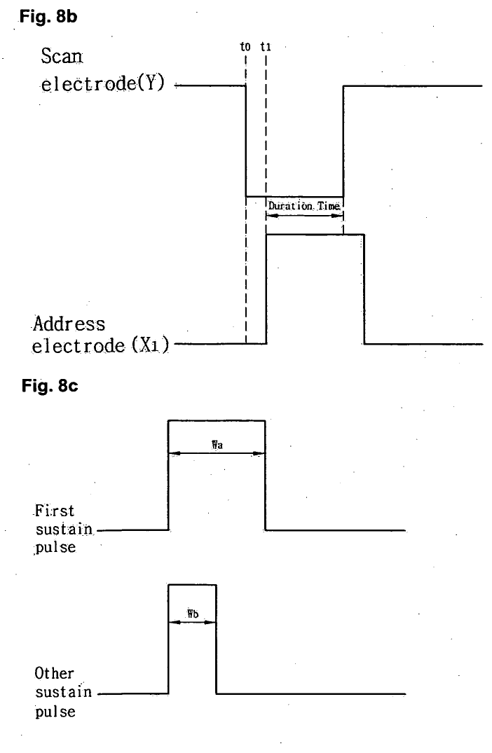

FIGS. 8a to 8c illustrate driving waveforms according to a method of driving the plasma display panel of the invention. As illustrated in FIG. 8a, the application time point of the data pulse applied to each of the address electrodes X₁ to Xₙ is different from that of the scan pulse applied to the scan electrode. In addition, the width of a first sustain pulse SUS applied in the sustain period is larger than that of other sustain pulses.

As illustrated in FIG. 8b, because the application time point of the scan pulse and the data pulse are different, the discharge duration time (i.e., the time during which the scan pulse and the data pulse overlap each other) is reduced. This reduction in the discharge duration time can weaken the address discharge. As a result, an adequate amount of wall charges may not be generated and the sustain discharge in the subsequent sustain period becomes unstable, thereby degrading the discharging efficiency of the plasma display panel. Therefore, during the sustain period of the sub-field in which the application time points of the scan pulse and the data pulse are different from each other, the width of the first sustain pulse is made to be wider in order to generate an adequate sustain discharge, thereby compensating for the insufficient wall charges due to the weak address discharge in an address period.

As illustrated in FIG. 8c, during the sustain period of the sub-field where the application time points of the scan pulse and the data pulse are different from each other, the width Wa of the first applied sustain pulse has a duration sufficient to compensate for the decreased amount of wall charges. That is, the first sustain pulse is held for a sufficient period of time, preferably in the range of one to five times the width Wb of another sustain pulse applied during the sustain period.

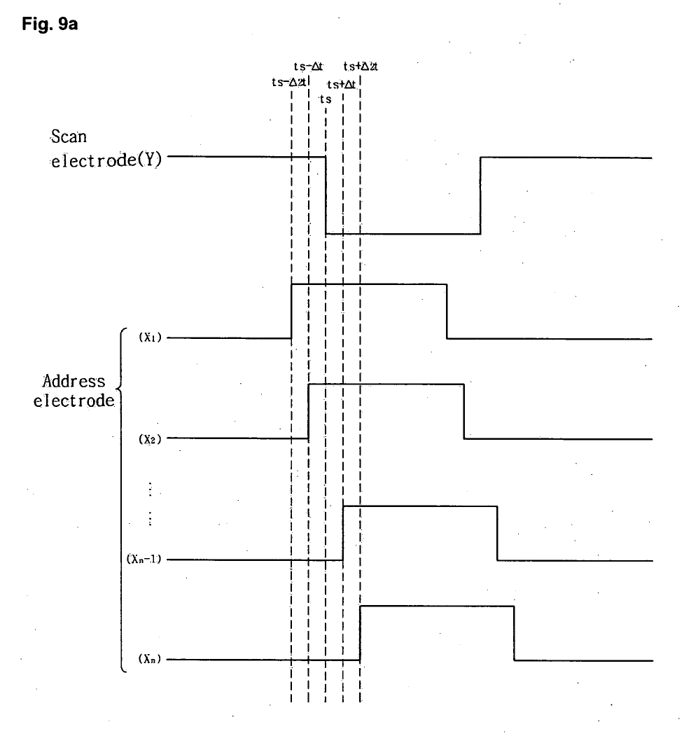

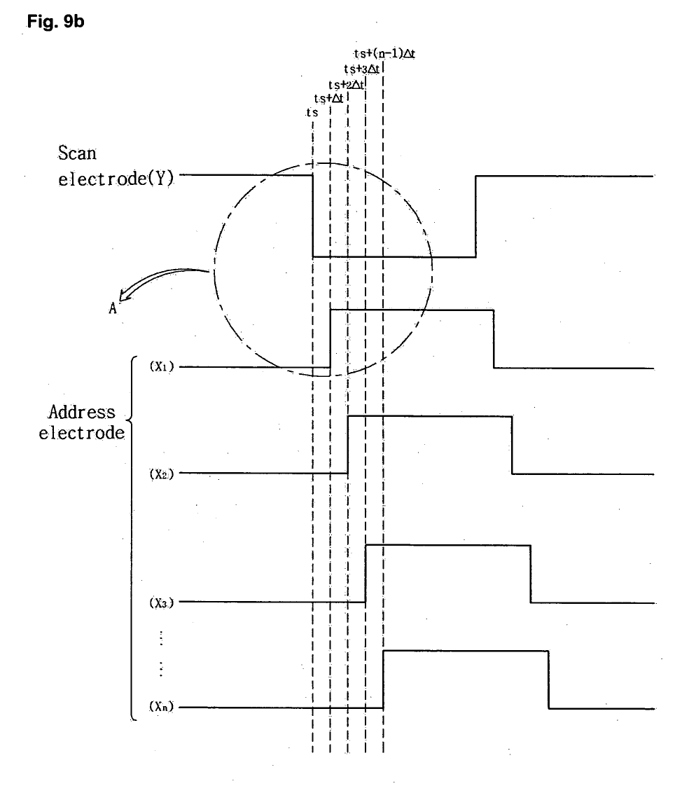

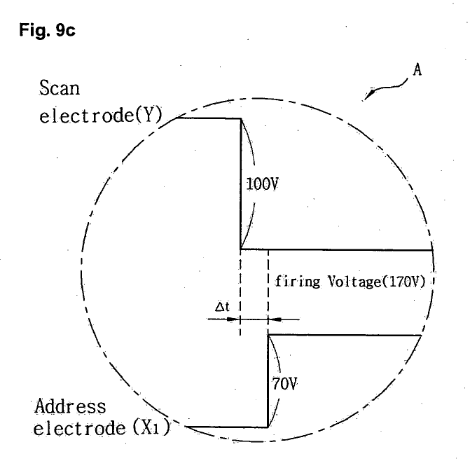

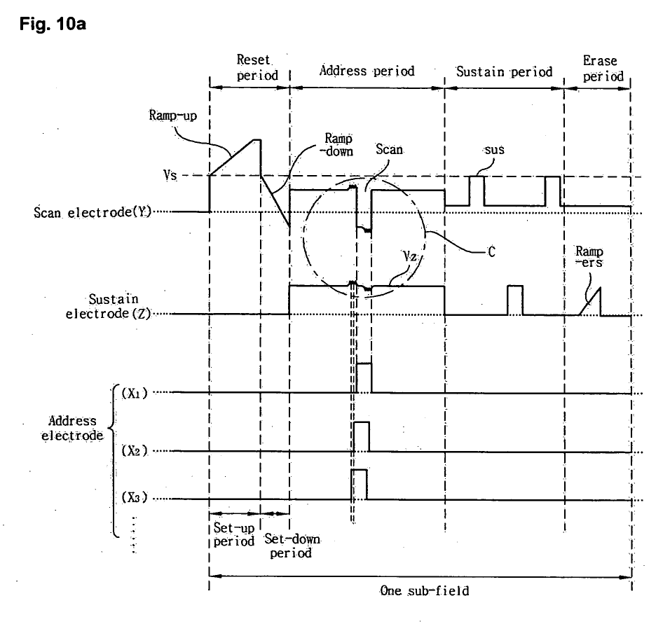

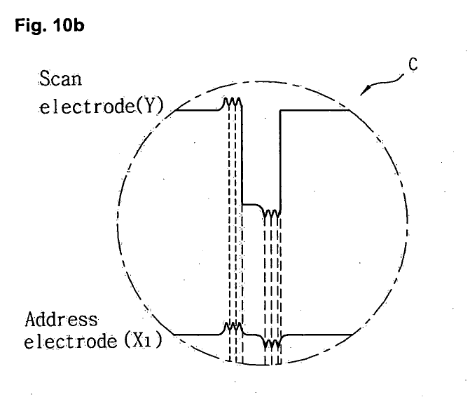

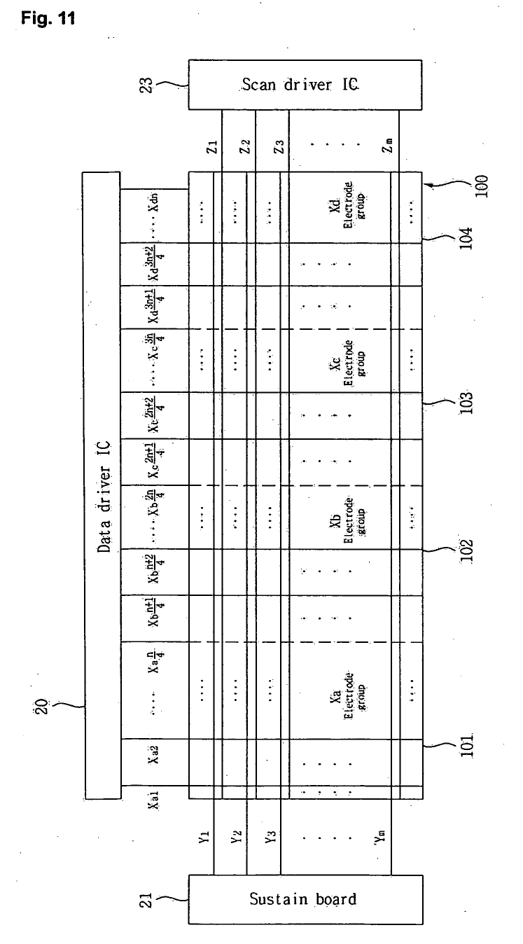

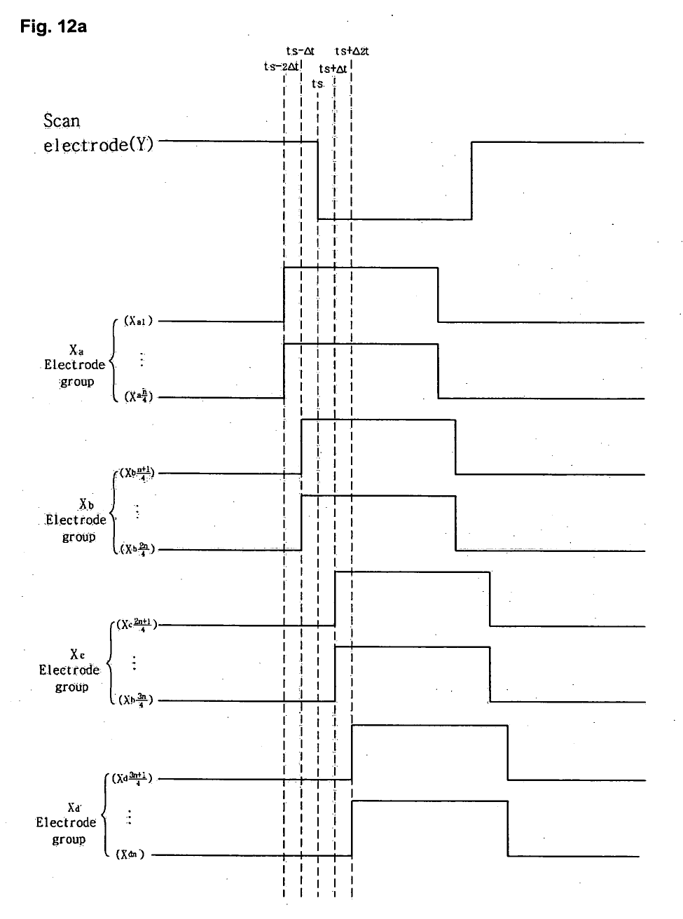

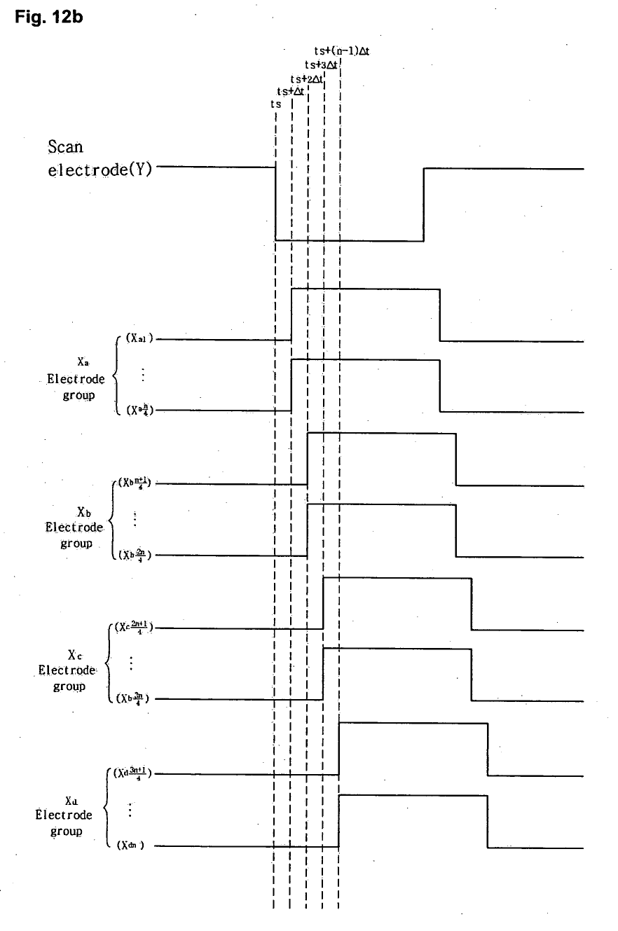

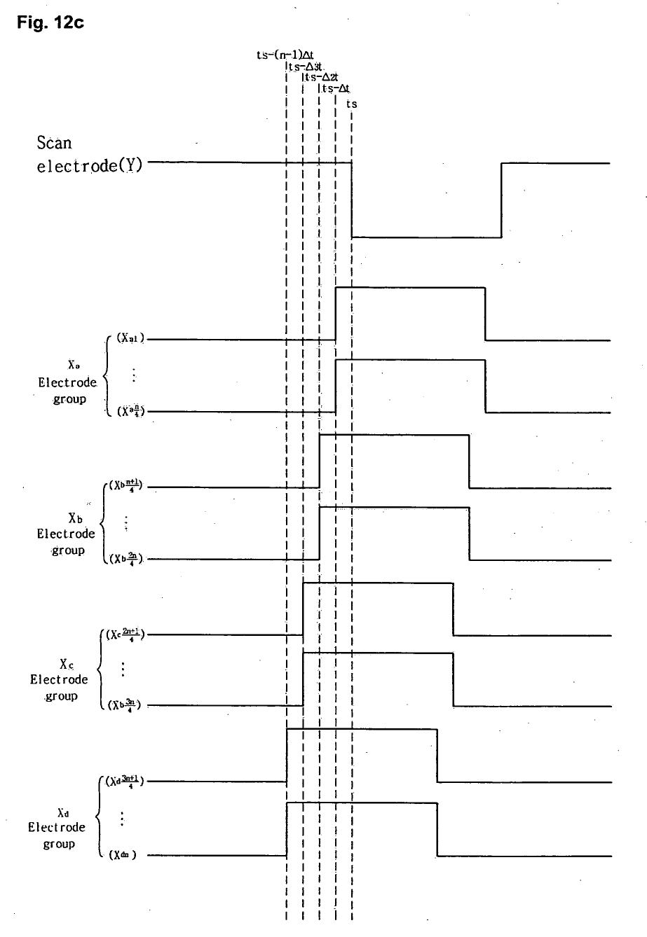

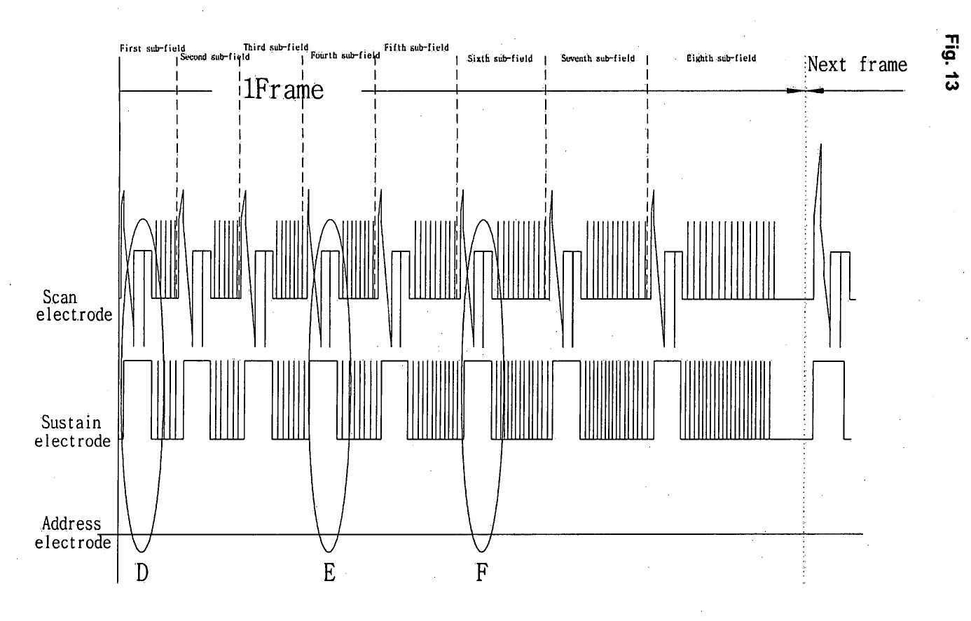

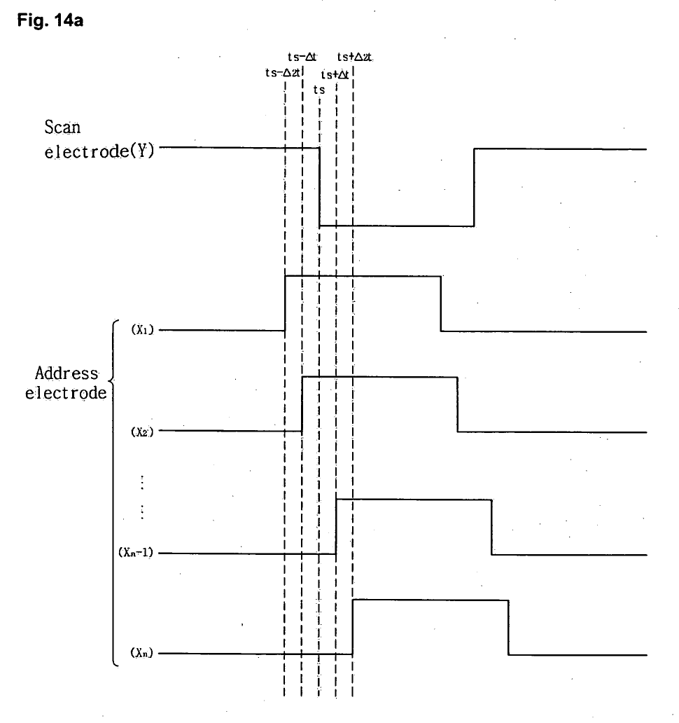

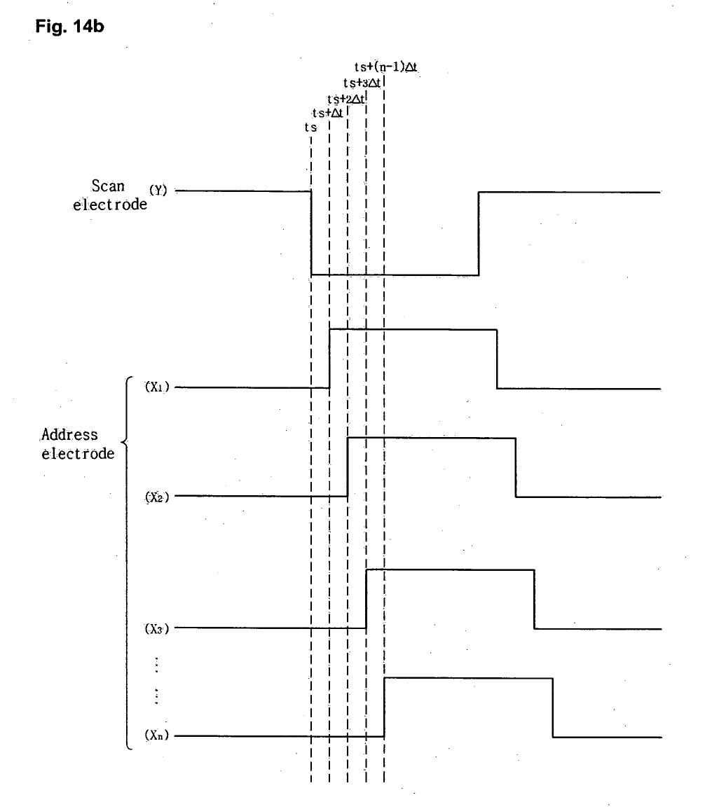

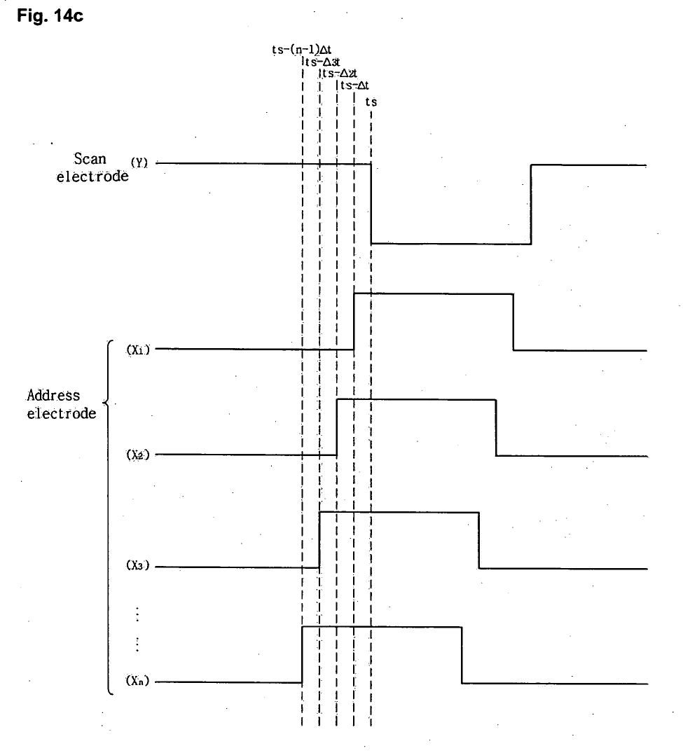

The application time point of the scan pulse applied to the scan electrode can be different from that of a data pulse applied to the address electrodes X₁ to Xₙ, in various ways. For example, the application time point of a data pulse applied to each of the address electrodes X₁ to Xₙ may be set with respect to the application time point of a scan pulse. This approach is explained below, with reference to FIGS. 9a to 9e.

Referring to FIGS. 9a to 9e, the scan pulse is applied to the scan electrode at a specific time ts (i.e., the scan pulse has an application time point of ts) and the data pulses applied to the address electrodes have various application time points which deviate from the application time point of the scan pulse. For example, as illustrated in FIG. 9a, the data pulses are applied to the address electrodes such that half the data pulses are applied prior to the scan pulse and half are applied later than the scan pulse by some predetermined factor Δt, assuming the total number, n, of address electrodes is 2. In the case of address electrode X₁, the data pulse is applied at a time point, which is 2Δt ahead of the scan pulse, i.e., ts−2Δt. In the case of address electrode X₂, a data pulse is applied at a time point, which is Δt ahead of that of the scan pulse applied to the scan electrode Y, i.e., ts−Δt. In this way, to the address electrode X₍ₙ₋₁₎, a data pulse is applied at a time point which is Δt after the scan pulse, i.e., ts+Δt, and to the address electrode Xₙ at a time point 2Δt after the scan pulse, i.e., ts+2Δt.

Alternatively, the application time point of the data pulse applied to each of the address electrode may be set to be later than that of the scan pulse, as illustrated in FIG. 9b. For example, assuming the scan pulse is applied to the scan electrode Y at a time point ts, a data pulse is applied to each of the address electrodes, according to the arranged order of the address electrodes X₁ to Xₙ, at a time point which is later than the application time point of the scan pulse by some predetermined factor. In the case of the address electrode X₁, a data pulse is applied at a time point, which is Δt after the scan pulse applied to the scan electrode Y, i.e., at a time point ts+Δt. In the case of the address electrode X₂, a data pulse is applied at a time point, which is 2Δt after that of the scan pulse applied to the scan electrode Y, i.e., at a time point ts+2Δt, and so on such that a data pulse is applied to the address electrode Xn at a time point, which is nΔt after that of the scan pulse, i.e., at a time point ts+Δt. Although all the application time points of the data pulse are established to after that of the scan pulse in FIG. 9b, the application time point of only a single data pulse may be set up so as to be behind that of the scan pulse.

FIG. 9c illustrates a detailed diagram of region A of FIG. 9b, assuming that the firing voltage of an address discharge is 170V, the scan pulse voltage is 100V, and the data pulse voltage 70V. In the region A, first, due to the scan pulse applied to the scan electrode Y, the voltage difference between the scan electrode Y and the address electrode X₁ becomes 100V. Then, some time, Δt, after application of the scan pulse, a data pulse is applied to the address electrode X1, increasing the voltage difference between the scan electrode Y and the address electrode X1 from 100V to 170V. The increased voltage difference between the scan electrode Y and the address electrode X₁ becomes a discharge firing voltage and thus an address discharge is generated between the scan electrode Y and the address electrode X₁.

Furthermore, the time points of the data pulses applied to the address electrodes may be established to precede that of the scan pulse applied to the scan electrode Y, while making it different all the application time points of the data pulse and the scan pulse, which are applied respectively to the address electrodes X₁ to Xₙ and the scan electrode Y. As illustrated in FIG. 9d, a data pulse is applied to each of the address electrodes, according to the arranged order of the address electrodes X₁ to Xₙ, at a time point which is prior to the application time point of the scan pulse by some predetermined factor Δt. In this case, a data pulse is applied to the first address electrode X₁ at a time point, which is nΔt ahead of the scan pulse, i.e., at the time point ts−nΔt. Likewise, a data pulse is applied to the second address electrode X₂ at a time point, which is (n−1)Δt ahead of the scan pulse, i.e., at a time point ts−(n−1)Δt, and so on until a data pulse is applied to the last address electrode at a time point ts−Δt. Although all the application time points of data pulse are established to come ahead of the time point of the scan pulse in FIG. 9d, the application time point of only a single data pulse may be set up so as to be ahead of that of the scan pulse. That is, the number of data pulses, of which application time point comes ahead of the scan pulse, may vary.

FIG. 9e illustrates a detailed diagram of region B of FIG. 9d, assuming that the firing voltage of an address discharge is 170V, the scan pulse voltage is 100V, and the data pulse voltage 70V. Because the data pulse applied to the address electrode X₁ before the scan pulse is applied, the voltage difference between the scan electrode Y and the address electrode X₁ is 70V. Then, some time, Δt, after the data pulse is applied the voltage difference between the scan electrode Y and the address electrode X₁ increases to about 170V because the scan pulse is applied. Accordingly, the voltage difference between the scan electrode Y and the address electrode X₁ becomes a discharge firing voltage and thus an address discharge is generated between the scan electrode Y and the address electrode X₁.

As described above, in conjunction with FIGS. 9a to 9e, the time difference between the application time points of the scan pulse and the data pulses applied to the scan electrode Y and the address electrodes X₁ to Xₙ, respectively, has been explained while introducing a concept of Δt. Also, the difference in the time points of the data pulses applied to the address electrodes X₁ to Xₙ has been explained in a similar manner. Here, for example, when the time point of a scan pulse applied to the scan electrode Y is ts, a time difference with a data pulse nearest to the time point ts of the scan pulse is Δt, and a time difference with a data pulse second-nearest to the time point ts of the scan pulse is twice of Δt, i.e., 2Δt. The Δt value remains constant. That is, while the time points of the scan pulse and the data pulse applied respectively to the scan electrode Y and the address electrodes X₁ to Xₙ are made different, the time difference between the time points of data pulses applied to each of the address electrodes X₁ to Xₙ remains the same.

Although the difference in the time points of the data pulses applied to the address electrodes X₁ to Xₙ is constant, the difference between the application time point of a scan pulse and the application time point of the data pulse applied nearest in time to the scan pulse may be constant or vary. For example, the time difference between the application time point ts of the scan pulse applied to a first scan electrode Y₁ and that of the data pulse nearest thereto can be Δt, and the time different between the scan pulse applied to a second scan electrode Y₂ and that of the date pulse nearest thereto may be 2Δt during the same address period.

Alternatively, the difference between the time point of a scan pulse and the data pulse applied closest thereto could be different for different sub-fields. Preferably the difference between the application time point of a scan pulse ts and that of a data pulse nearest thereto is in the range of 10 ns to 1000 ns, considering the limited time of an address period. Furthermore, considering the width of a scan pulse, the value of Δt is preferably in the range of 1 percent to 100 percent of the width of a predetermined scan pulse. For example, if the width of the scan pulses is 1 μs, the time difference Δt is preferably in the range of 10 ns to 100 ns.

The difference between the application time point of the data pulses applied to adjacent address electrodes may vary. For example, if the time point of a scan pulse applied to the scan electrode Y is 0 ns, and a data pulse is applied to a first address electrode X₁ at a time point of 10 ns, the difference in the time points of the scan pulse and the data pulse is 10 ns. Then a data pulse is applied to the next address electrode X₂ at a time point of 20 ns, resulting in a difference between the time points of the scan pulse and the data pulse applied to the address electrode X₂ of 20 ns. However, the difference between the time points of the data pulses applied to the address electrodes X₁ and X₂ is 10 ns. Furthermore, to the next address electrode X₃, a data pulse is applied at a time point of 40 ns, and thus the difference in the time points of the scan pulse and the data pulse applied respectively to the scan electrode Y and the address electrode X₃ becomes 40 ns. Therefore, the time points of the data pulses applied to the address electrodes X₂ and X₃ respectively have a difference of 20 ns.

As described above, if the time point of a scan pulse applied to the scan electrode Y is different from that of a data pulse applied to the address electrodes X₁ to Xₙ, the noise in the waveforms applied to the scan electrode and the sustain electrode is reduced due to the reduction in the coupling through the capacitance of the panel, as illustrated in FIGS. 10a and 10b.

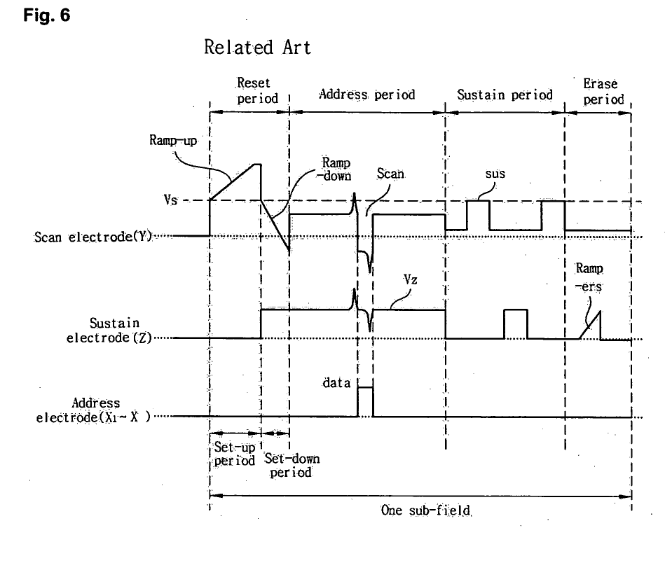

Referring to FIG. 10a, it can be seen that the noise in waveforms applied to the scan electrode and the sustain electrode is considerably reduced when compared to the noise in conventional driving methods as shown in FIG. 6. The reduced noise is illustrated in greater detail in FIG. 10b. At the point in time when the data pulse is abruptly raised, the rising noise occurring in the waveforms applied to the scan electrode and the sustain electrode is alleviated. Likewise, at the point in time when the data pulse falls rapidly, the falling noise occurring in the waveforms applied to the scan electrode and the sustain electrode is reduced.

Furthermore, the width of a first sustain pulse is set up to be relatively longer, and thus unstable sustain discharge caused by reduction in the discharge duration time is prevented. The reduced discharge duration time may occur due to the difference in the application time points of the data pulse and the scan pulse.

Accordingly, the address discharge generated in an address period becomes stable, thereby preventing reduction in the driving efficiency of a plasma display panel. Furthermore, because the address discharge of a plasma display panel is stabilized, a single scan mode may be employed where a single driver scans the entire panel.

FIG. 11 illustrates a plasma display apparatus according to another embodiment of the invention, where the address electrodes X₁ to Xₙ are divided into a plurality of address electrodes groups. As illustrated in FIG. 11, the address electrodes X₁ to Xₙ are divided into, for example, four address electrode groups. Address electrode group Xa includes address electrodes Xa₁ to Xa_{n/4} (101), address electrode group Xb includes electrodes Xb_{(1+n/4)} to Xb_{2n/4} (102), address electrode group Xc includes electrodes Xc_{(1+2n/4)} to Xc_{3n/4} (103), and address electrode group Xd includes electrodes Xd_{(1+3n/4)} to Xdₙ (104). A data pulse is applied to the address electrodes belonging to at least one of the above electrode groups at a time point different from that of a scan pulse applied to the scan electrode Y. That is, while the application time point of a data pulse applied to all the electrodes (Xa₁ to Xa_{n/4}) belonging to the Xa electrode group is different from that of a scan pulse to the scan electrode Y, they are all the same within the Xa electrode group. In addition, while the data pulses applied to the electrodes belonging to the remaining electrode groups 102, 103, and 104 can be applied at time points that are either the same or different from the time point of the scan pulse, all the time points are different from the application time point of a data pulse of the electrodes belonging to the first electrode group 101.

Although the number of electrodes belonged to each electrode group 101 to 104 illustrated in FIG. 11 is the same, each group may include a different number of electrodes, and/or the number of electrode groups may vary. Preferably, the number of electrode groups N is more than two and less than the total number of address electrodes, i.e., in a range of 2≦N≦(n−1).

FIGS. 12a to 12c illustrate examples of applying a date pulse to the address electrodes in a driving waveform of a plasma display panel according the second embodiment of the invention. As illustrated in FIGS. 12a to 12c, the address electrodes X₁ to Xₙ are divided into a plurality of address electrode groups (Xa, Xb, Xc, and Xd) and, during the address period of at least one sub-field, the time point of the data pulses applied to the address electrodes belonging to at least one of the electrode groups is different from that of a scan pulse applied to the scan electrode Y. In addition, similar to the cases illustrated in FIGS. 8a to 8c, the width of the first sustain pulse applied during the sustain period is longer than another sustain pulse.

For example, as illustrated in FIG. 12a, assuming that a scan pulse is applied to the scan electrode Y at a time point ts, the data pulses applied to the electrodes belonging to each group, according to the arranged order of address electrode groups, are applied before and after the time point of a scan pulse application to the scan electrodes. In the case of the address electrodes (Xa₁ to Xa_{n/4}) belonging to the electrode group Xa, a data pulse is applied at a time point, which is 2Δt ahead of or prior to the application time point of the scan pulse applied to the scan electrode Y, i.e., at a time point ts−2Δt. In the case of the address electrodes (Xb_{1+(n/4)} to Xb_{2n/4}) belonging to the electrode group Xb, a data pulse is applied at a time point, which is Δt ahead of the scan pulse applied to the scan electrode Y, i.e., at a time point ts−Δt. In this way, to the address electrodes (Xc_{(2n+1)/4} to Xc_{3n/4}) belonging to the electrode group Xc, a data pulse is applied at a time point ts+Δt, and to the address electrodes (Xd_{1+(3n/4)} to Xdₙ) belonging to the electrode group at a time point ts+2Δt. However, the application time point of a data pulse applied to the address electrodes of at least one electrode group among the plural electrode groups may be set to come behind that of the scan pulse applied to the scan electrode Y as illustrated in FIG. 12b.

Alternatively, the application time points for the data pulses applied to each electrode groups may be after the application time point of the scan electrode as illustrated in FIG. 12b, or all the data pulse application time points may precede the application time point of the scan electrode as illustrated in FIG. 12c. In FIGS. 12b and 12c, all the application time points of the data pulse are set to come before or after that of the scan pulse, however, the application time point of a data pulse applied to the address electrodes belonged to only one address electrode group among the plural address electrode groups may be set to be before or after that of the scan pulse. That is, the number of address electrode groups, of which application time point are set behind and/or ahead of the scan pulse, may vary.

As described above, in an address period, if the time point of a scan pulse applied to the scan electrode Y is made different from that of a data pulse applied to each address electrode group, the noise in the waveforms applied to the scan electrode and the sustain electrode is reduced, due to the reduction in the coupling through the capacitance of the panel at each time point of the data pulse applied to each respective address electrode group including the address electrodes X₁ to Xₙ, in a similar manner as in FIGS. 10a and 10b.

Furthermore, the width of a first sustain pulse is set to be wider than another sustain pulse applied during the sustain period, in order to compensated for the reduction in the discharge duration time.

Accordingly, the address discharge generated in an address period becomes stable, thereby preventing reduction in the driving efficiency of a plasma display panel. Furthermore, because the address discharge of a plasma display panel is stabilized, a single scan mode may be employed where a single driver scans the entire panel.

As described above, within one sub-field, the application time point of a data pulse may be set up to differ from that of a scan pulse applied to the scan electrode. Alternatively, with respect to and within one frame, the application time point of a scan pulse and a data pulse applied respectively to the scan electrode Y and the address electrodes X1 to Xn or the address electrode groups Xa, Xb, Xc and Xd can be set to be different from one another, and simultaneously, within each respective sub-field, the application time point of a data pulse applied to the address electrodes may be establish so as to differ from each other. This driving waveform is illustrated in FIG. 13.

As illustrated in FIG. 13, in the driving waveforms according to the invention, during at least one sub-field, the difference in the application time points of a data pulse applied to the address electrodes is the same, but the application time point of a scan pulse and a data pulse applied respectively to the scan electrode and the address electrodes are different from each other. During the address period of at least one sub-field of the frame, the time difference between data pulses applied to the address electrodes is different from the time difference between data pulses in the address period of another sub-field of the frame. In addition, in the sub-field where the application time points of a data pulse and a scan pulse are set to be different from each other, the width of a first sustain pulse applied in the sustain period is established so as to be larger than other sustain pulses.

For example, during the first sub-field of a frame, the application time point of the data pulses applied to the address electrodes X1 to Xn is different from that of a scan pulse applied to the scan electrode Y, and the time difference between the application time point of the data pulses applied to adjacent address electrodes is Δt. During a second sub-field, similar to the first sub-field, the application time point of the data pulses applied to the address electrode X₁ to Xₙ is different from that of a scan pulse applied to the scan electrode Y, and at the same time, the time difference between the application time point of the data pulses applied to adjacent address electrodes is 2Δt. In this way, with respect to each respective sub-field of the frame, the difference in the application time points of a data pulse applied to adjacent address electrodes may be different between sub-fields, such as 3Δt, 4Δt, and the like.

Likewise, the difference between the application time point of the data pulse and the application time point of a scan pulse can vary between sub-fields. For example, during one sub-field, the data pulses applied to one electrode group may be applied prior to the scan pulse, while the data pulses applied to a second group are applied after as illustrated in FIG. 14a. During a second sub-field, the data pulse applied all the electrode groups may be applied after the scan pulse as illustrated in FIG. 14b. Finally, during a third sub-field, the data pulses applied to all the electrode groups may be applied before or prior to the scan pulse as illustrated in FIG. 14c. The driving waveforms shown in FIGS. 14a to 14c are substantially the same as those in FIGS. 9a, 9b and 9c. Thus, further details thereon will not be repeated here.

As described above, if the time points of a scan pulse and a data pulse applied respectively to the scan electrode Y and the address electrodes X₁ to Xₙ are different from one another during the address period with respect to each respective sub-field, the noise in waveforms applied to the scan electrode and the sustain electrode can be reduced, due to a reduction in the coupling through the capacitance of the panel at each time point of the data pulse applied to the address electrodes X₁ to Xₙ.

Furthermore, the width of a first sustain pulse is set up to be relatively larger, and thus unstable sustain discharge caused by reduction in the discharge duration time can be prevented. The reduced discharge duration time may occur due to the difference in the application time points of the data pulse and the scan pulse.

It is understood to those skilled in the art that the present invention can be embodied in various other forms, without departing from the scope and features of the invention. For example, in the forgoing description, a data pulse is applied to all the address electrodes X₁ to Xₙ at a time point different from the application time point of a scan pulse, or all the address electrodes are divided into four electrode groups having the same number of address electrodes according to the arranged order thereof and, for each electrode group, a data pulse is applied at a time point different from that of a scan pulse. Alternatively, however, the odd number electrodes among the all the address electrodes X₁ to Xₙ are established as one electrode group and the even number electrodes are established as another electrode group. Then, within the same electrode group, a data pulse is applied to all the address electrodes at the same time point and the application time point of a date pulse for the respective electrode group may be set up to be different from that of a scan pulse.

In addition, the address electrodes X₁ to Xₙ are divided into plural electrode groups in such a way that at least one electrode group has a different number of address electrodes, the application time point of a data pulse may be set up to be different from that of a scan pulse for each respective electrode group. For example, if the application time point of a scan pulse applied to the scan electrode Y is ts, a data pulse is applied to the address electrode X₁ at a time point ts+Δt, to the address electrode X₂ to X₁₀ at a time point ts+3Δt, and to the address electrode X₁₁ to Xₙ at a time point ts+4Δt, etc. That is, the driving method of a plasma display panel according to the invention may be modified in various ways.

As described above, according to the invention, the application time point of a data pulse applied to the address electrode in the address period is controlled, and thus noises occurring in waveforms applied to a scan electrode or a sustain electrode can be reduced to stabilize the address discharge, thereby stabilizing the driving of a plasma display panel and improving the driving efficiency thereof.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for driving a plasma display panel, the plasma display panel comprising a scan electrode, a plurality of address electrodes crossing the scan electrode, and a controller for driving the panel, the method comprising:
dividing the plurality of address electrodes into a plurality of address electrode groups;
applying a data pulse to each of the plurality of address electrode groups in association with a scan pulse, wherein an application time point for at least one of the plurality of address electrode groups is different from that of the other data electrode groups during an address period of at least one sub-field, and
wherein the width of a least one sustain pulse applied to the scan electrode during a sustain period of the at least one sub-field is greater than that of another sustain pulse applied to the scan electrode during the at least one sub-field.

2. The method as claimed in claim 1, wherein an application time point for at least one of the plurality of address electrode groups is prior to an application time point of the scan pulse.

3. The method as claimed in claim 2, wherein the application time points for the plurality of address electrode groups are prior to an application time point of the scan pulse

4. The method as claimed in claim 1, wherein an application time point for at least one of the plurality of address electrode groups later than to an application time point of the scan pulse.

5. The method as claimed in claim 4, wherein the application time points for the plurality of address electrode groups are later than an application time point of the scan pulse.

6. The method as claimed in claim 1, wherein the number of the address electrode groups greater than one, but less than the total number of the address electrodes.

7. The method as claimed in claim 1, wherein each of the address electrode groups includes the same number of the address electrodes

8. The method as claimed in claim 1, wherein at least one of the plurality of address electrode groups includes a different number of address electrodes.

9. The method as claimed in claim 1, wherein the width of the at least one sustain pulse ranges from about 1 to 5 times of another sustain pulse applied to the scan electrode during the at least one sub-field.

10. A plasma display apparatus comprising:
a scan electrode;
a plurality of address electrodes, the plurality of address electrodes crossing the scan electrode;
a scan driver for driving the scan electrode;
a data driver for driving the plurality of address electrodes; and
a controller for applying a data pulse to each of a plurality of data electrode groups in association with a scan pulse, wherein an application time point for at least one of the plurality of data electrode groups is different from that of the other data electrode groups during an address period of at least one subfield, where each of the plurality of data electrode groups includes one or more address electrodes; and
wherein the width of a first sustain pulse applied to the scan electrode after the address period of the at least one subfield is wider than that of another sustain pulse applied to the scan electrode during the at least one subfield.

11. The apparatus as claimed in claim 10, wherein an application time point for at least one of the plurality of data electrode groups is prior to an application time point of the scan pulse.

12. The apparatus as claimed in claim 11, wherein the application time points for the plurality of data electrode groups are prior to an application time point of the scan pulse.

13. The apparatus as claimed in claim 10, wherein an application time point for at least one of the plurality of data electrode groups later than to an application time point of the scan pulse.

14. The apparatus as claimed in claim 13, wherein the application time points for the plurality of data electrode groups are later than an application time point of the scan pulse.

15. The apparatus as claimed in claim 10, wherein the number of data electrode groups is more than one, but less than the total number of address electrodes.

16. The apparatus as claimed in claim 15, wherein each data electrode group includes one or more address electrodes.

17. The apparatus as claimed in claim 10, wherein the width of the first sustain pulse ranges from 1 to 5 times the width of another sustain pulse applied to the scan electrode during the at least one sub-field.

18. A plasma display apparatus comprising:
a scan electrode;
a plurality of address electrodes, the plurality of address electrodes crossing the scan electrode;
a scan driver for driving the scan electrode;
a data driver for driving the plurality of address electrodes; and
a controller for applying a data pulse to each of a plurality of address electrode groups in association with a scan pulse, wherein an application time point for at least one of the plurality of address electrode groups is different from that of the other address electrode groups during an address period of at least one subfield, where each of the plurality of address electrode groups includes one or more address electrodes; and
wherein the width of a least one sustain pulse applied to the scan electrode during a sustain period of the at least one sub-field is greater than that of another sustain pulse applied to the scan electrode during the at least one sub-field.
